(19) United States
(12) Patent Application Publication
(10) Pub. No.: US 2012/0156348 A1
(43) Pub. Date: Jun. 21, 2012

(54) DEVICE AND METHOD FOR THERMALLY PROCESSING FOOD PRODUCTS

(76) Inventors: Bernard Cadoret, Le Rheu (FR); Jean-Luc Dreano, Ploermel (FR)

(21) Appl. No.: 13/079,311

(22) Filed: Apr. 4, 2011

(30) Foreign Application Priority Data
Dec. 15, 2010 (FR) 1004909

(51) Int. Cl. A47J 27/00; A23L 1/01

(52) U.S. Cl. 426/523; 99/407; 99/355

(57) ABSTRACT

Device and method for thermally processing food products, comprising a receptacle which is intended to receive food products, a thermal processing bath downstream of the receptacle, the receptacle having a cross-section in the form of a chute, a supply of thermal processing water with the food products being moved into the receptacle by the water, and a sluice arranged downstream of the receptacle, the sluice having at least one open position which allows the thermal processing water and the food products moved by the thermal processing water to pass, and a closed position which retains the food products in thermal processing water, the thermal processing bath comprising a thermal processing water vessel which is arranged downstream of the sluice, and a member for timing the duration of the thermal processing operation, the timing member being provided with vanes, the sluice being synchronised with the timing member in the closed position when a vane is opposite the sluice and in an open position when the access to the thermal processing water vessel is free.

### FIELD OF THE INVENTION

The present invention relates to the thermal processing of sensitive food products, for example, of the sausage type.

### BACKGROUND OF THE INVENTION

Traditionally, this type of product is pushed into a natural skin whose availability is not always ensured and costs fluctuate significantly.

Alternatives to natural skin have existed for a number of years, in the form of edible gels which are applied to the surface of the products and which form a casing around the product. However, this casing is extremely fragile and adhesive, which brings about the risk of products becoming bonded to each other or to elements of a production line.

Such products can be steam cooked. However, handling them is a complex operation. The thermal and products yields of such a cooking operation are rarely satisfactory.

The invention also relates to the processing of food products which have no casing. Some food products without any skin must be handled with a great deal of care whilst complying with strict hygiene rules.

An object of the invention is to improve the situation.

### SUMMARY OF THE INVENTION

To this end, a device for thermally processing food products comprises a receptacle which is intended to receive food products and a thermal processing bath downstream of the receptacle. The receptacle has a cross-section in the form of a chute. The receptacle comprises a supply of thermal processing water with the food products being moved into the receptacle by the water. A sluice is arranged downstream of the receptacle. The sluice has at least one open position which allows the thermal processing water and the food products moved by the thermal processing water to pass, and a closed position which retains the food products in thermal processing water. The thermal processing bath comprises a thermal processing water vessel which is arranged downstream of the sluice. The thermal processing bath comprises a member for timing the duration of the thermal processing operation. The timing member is provided with vanes. The sluice is synchronised with the timing member in a closed position when a vane is opposite the sluice and in an open position when the access to the thermal processing water vessel is free.

The food product can be received in the receptacle which is supplied with water. The food product is moved by the water then, depending on the position of the sluice, either moved into the thermal processing bath, or temporarily retained in the sluice when a vane is opposite the sluice, thereby preventing impact of the food product against the vane. The food product temporarily retained is released when the sluice is opened and moved into the thermal processing bath. The food product then travels into the thermal processing bath for the period of time necessary for it to be cooked. Since the water supplied to the receptacle is thermal processing water, the cooking of the food product begins as soon as the receptacle is reached. The water provides a multiple function of transport, protection and cooking. Since the thermal processing begins from contact with the thermal processing water in the receptacle, the fragility of the food product linked to the absence of skin or the presence of a non-stabilised and adhesive skin is very soon reduced. Owing to the sluice, the food product remains in the thermal processing water in a substantially continuous manner between being received in the receptacle and arriving in the thermal processing bath. Continuity of thermal processing is thus ensured, whilst preventing deformation of the products linked to impact with each other or to their arrangement on a surface which has the effect of modifying their shape. The water which supplies the receptacle may originate from the thermal processing bath. The cooking of the food product may begin as soon as the receptacle is reached.

In one embodiment, the supply of thermal processing water to the receptacle is continuous. It is possible to use a pump with continuous operation. Intermediate storage of water between the pump and the receptacle is optional. Intermediate storage of water allows the provision of, for example, a heat-exchange operation in order to keep the temperature in the receptacle constant, or filtration or surface skimming which allows materials in suspension to be eliminated.

In one embodiment, the receptacle is flared in a downstream direction. Since the receptacle widens in the direction towards the sluice, the temporary storage of food products in the sluice is facilitated. The distribution of the food products in the sluice in a closed position is also facilitated.

In one embodiment, the receptacle comprises a portion adjacent to the sluice, the portion being inclined in a downstream direction. The inclination may be between 5 and 25° relative to the horizontal. The inclination of the receptacle, in particular the base of the receptacle, in the region of the sluice, allows the sluice and the products temporarily stored to be completely emptied when the sluice is opened. In this instance, the term width of the sluice is intended to be understood as the dimension perpendicular relative to the flow axis of the thermal processing water in the opening position of the sluice. The inclination of the portion of the receptacle adjacent to the sluice also allows a degree of acceleration of the flow of thermal processing water by the effect of gravity, which results in an increase in the distance between two food products. This facilitates high-speed operation whilst reducing the risk of impacts between two food products.

In one embodiment, the sluice comprises a door which is articulated to a horizontal shaft. The shaft of the sluice door can be arranged along the width of the sluice. The horizontal shaft allows controlled movement of the door between the closed position and the open position and vice-versa. The door, in the open position of the sluice, is located downstream of the horizontal shaft. When moving from the open position to the closed position, the door is raised upwards counter to the flow direction of the thermal processing water. As long as the thermal processing water, at the start of movement into the closed position, can pass above the door, the food products can also continue to pass whilst remaining substantially immerged. As soon as the flow is greatly reduced, the accumulation of water is produced in the sluice and the food products then cease to pass above the door and are retained in the thermal processing water held in the sluice. Possible occurrences of jamming of the food product or prolonged losses of contact of the food product with the thermal processing water are thus prevented. The door in the open position is arranged under the flow of water. The risks of food products becoming bonded to the door are reduced.

In one embodiment, the sluice comprises a door which is provided with at least one hole for the flow of water. The hole limits the rise of the level of water retained in the sluice. It is thus possible to prevent water from overflowing via the upper edge of the sluice in the closed position. The food products thus remain temporarily stored in the water retained by the sluice. The hole can be provided at a height selected with a view to an accumulation of thermal processing water over a height equal to several times the diameter of the food products, for example, from ten to twenty times the diameter of the food products, whilst preventing overflow above the door of the sluice.

The door of the sluice may comprise, in the closed position of the sluice, a substantially solid lower portion in order to promote a rapid accumulation of thermal processing water, an intermediate zone which is provided with the hole(s) and a substantially solid upper zone. Such an arrangement has been found to be well suited to food products which have a tendency to float. For food products which have a density which is similar to that of water, the holes could be arranged at a greater height, for example in the upper zone of the door.

In one embodiment, the sluice comprises a door which has lateral edges which are located at a distance from corresponding fixed edges that is independent of the position of the door. That is to say, the sluice is provided with lateral walls which are located at a distance from the lateral edges of the sluice that is small relative to the diameter of the food products. The distance may be substantially constant during the movement of the door. The risk of the food products becoming jammed is reduced.

In one embodiment, the timing member further performs a driving function, a grouping function and a function involving extracting the food products at the outlet. The vanes of the timing member separate the vessel of thermal processing water into a plurality of zones with circulation of thermal processing water between the zones and the food products being kept within the same zone. The vanes may be open-work. The depth of the thermal processing water in the vessel is substantially retained regardless of the position of the vanes. The length of time for which a food product remains in the vessel is determined by the speed of the vanes. The timing member may comprise an endless chain which is driven by toothed wheels, the endless chain being provided with links. The vanes can be supported by links. The vanes may be provided with holes which ensure the circulation of thermal processing water between the zones. The vessel may be substantially horizontal.

In an embodiment, the receptacle comprises an upstream portion having a level of thermal processing water independent of the position of the sluice. It is thus ensured that the food products are received in accordance with their characteristics, in particular, density, shape, etc. Once received, the food products can be caused to move with a movement which has a horizontal component and a vertical component. The food products can thus fall into the thermal processing water of the upstream portion of the receptacle from another machine, for example, a transfer member or a cutting machine. A level of thermal processing water which is independent of the position of the sluice allows the risk of impact of the food product against a base wall of the upstream portion to be reduced.

In one embodiment, the upstream portion comprises an inlet for thermal processing water which is lateral relative to the movement of the food products. The occurrences of turbulence in the thermal processing water thus move the products and prevent them from sinking and stagnating at the bottom of this inlet zone. The upstream portion may comprise an axial outlet for thermal processing water and food products. The lateral water inlet may be arranged close to an upstream wall of the receptacle. The water flows in a sufficiently laminar manner to move the food products.

The thermal processing water inlet may be bilateral. The regularity of the flow is promoted, at least in a vertical plane, which results in a reduction of the risk of impact of food products against a lateral wall of the upstream portion.

In one embodiment, the upstream portion comprises an upper opening for receiving food products, a base and an outlet for thermal processing water and food products in the direction towards the sluice. The speed of the water at the outlet allows the speed of the food products to be adjusted at the outlet in accordance with the rate at which the food products are received, for example, substantially equal in order to prevent an accumulation of food products in the upstream portion. The upstream portion may comprise an adjustment valve for the outlet. The position of the adjustment valve determines both the depth of water in the upstream portion and the flow rate of the water in the outlet. The position of the valve may be adapted to different types of food product.

In one embodiment, the receptacle comprises a downstream portion which comprises a base which is offset from a base of the upstream portion by a threshold. The height of the threshold may be between one and five centimetres. The threshold allows the prevention, or at the very least the reduction, of any counter-pressure of the water in the downstream portion which reduces the outlet flow of the upstream portion. The threshold promotes the maintenance of a constant level of water in the upstream portion. The threshold promotes an increase in the speed of the water flow in the downstream portion which results in a reduction of the risk of contact between two food products.

In one embodiment, the downstream portion comprises a base having an inclination which is less than or equal to the inclination of the sluice in the open position, which results in an acceleration of the flow of thermal processing water into the sluice in the open position. The risk of contact between food products is reduced.

In one embodiment, the position of the sluice is determined in accordance with the presence of a vane at the inlet of the bath. A vane sensor is mounted at the inlet of the bath.

The invention also relates to a processing line comprising a pushing device for food products, a cooker and a cooler. At least one of the cooker and the cooler comprises a device as described above. The thermal processing device can be arranged between the pushing device and the cooker. The thermal processing device can also be arranged between the cooker and the cooler. In this instance, the thermal processing liquid can be at the same temperature as the liquid of the cooler, for example, between −15 and 5° C. In the case of a thermal processing device which is arranged upstream of the cooker, the thermal processing water is at a temperature which is substantially equal to the temperature of the water of the cooker, for example, between 60 and 95° C.

A processing line may comprise a pushing device for food products, a pre-cooker, a packaging means, a pasteuriser and a cooler. At least one of the pre-cooker, the pasteuriser and the cooler comprises a device as described above.

A method for thermally processing food products may comprise receiving the food products in a receptacle which has a cross-section in the form of a chute which is supplied with thermal processing water, a flow in the receptacle moving the food products, the food products being directed towards a bath by feed downstream of the receptacle, an open position of a sluice allowing the thermal processing water and the food products carried by the thermal processing water to pass and a closed position of the sluice retaining the food products in thermal processing water; then the timed thermal processing of the food products in the bath comprising a vessel of water for thermally processing the food products, the introduction and the removal of the food products being controlled by vanes, feed being synchronised with the timing member with a closure action when a vane is opposite the sluice and an opening action when the access to the bath is free.

The invention is well-suited to co-extruded sausages but can be used for a number of other products which are not shaped or packaged. The invention is well-suited to products with no casing, in particular vegetables, food balls, sausages in a natural casing, emulsions without casings, prawns, pastes. The device allows the food products to be cooked or chilled in water so as to respect the integrity of the products.

### BRIEF DESCRIPTION OF THE DRAWINGS

The present invention will be better understood from an examination of the detailed description of some embodiments taken by way of non-limiting example and illustrated by the following Figures, in which:

FIG. 1 is a schematic view of a processing line;

FIG. 2 is a schematic view of another processing line;

FIGS. 3 to 5 are sectional views of a processing device in different operating positions;

FIGS. 6 and 7 are perspective views of a receptacle and a processing device sluice.

### DETAILED DESCRIPTION OF THE INVENTION

A number of food products which are marketed after cooking or pre-cooking are found to be particularly mechanically fragile in the raw state. This is the case for meat balls, a number of types of sausages based on meat, fish or even vegetables. This is also the case for sweet compositions of the dessert type, ready-to-eat cheese products, etc.

The Applicant has realised that there was an underlying demand for a thermal processing machine which is capable of processing various types of fragile food product by means of immersion in water.

In the case of food products which are covered in gel, for example, sausages for which the gel replaces the traditional skin, the fact that the gel in the raw state is particularly adhesive and is deposited in a thin layer adds to the mechanical fragility of the product. The food product which is covered with gel, in the raw state, is capable of bonding to a number of solid surfaces. The gel could become torn. Cooking devices as proposed in documents EP 234068 or GB 895101 involve risks of food products coming into contact with walls and are found to be very difficult to clean. There are consequently long and costly idle periods. Documents DE 2228564 and U.S. Pat. No. 3,761,290 describe hot water bath cookers in which the sausages are moved with a mechanism which is unsuitable for receiving fragile food products owing to the risk of impacts or becoming bonded to the mechanism.

Documents U.S. Pat. No. 3,700,847 and US 2008/279 990 describe a production operation for sausages on parallel production lines but are found to be unsuitable for food products which are adhesive and fragile. The parallel production lines take up a significant length of building space, which is found to be costly.

The Applicant has improved a device which allows food products which are adhesive, fragile or both to be received and cooked. The thermal processing device allows cooking by means of immersion in water which provides a much better energy yield than steam. The thermal processing device receives the food products from a machine which is arranged upstream, in the thermal processing water, which begins to immediately decrease the adhesive properties and/or the fragility of the food product. The food product is received in thermal processing water and is kept in the thermal processing water as far as the cooking bath whilst being transported by the thermal processing water.

In the embodiment illustrated in FIG. 1, a processing line comprises a food product pushing device 1 which receives at the inlet a raw material or a semi-finished material. The pushing device 1 provides at the outlet a raw food product. Downstream of the pushing device 1, the line comprises a cooker 2 which receives the raw food products from the pushing device 1. The cooker 2 is provided with a thermal processing device 4 as described below. The cooker 2 provides at the outlet a cooked food product. The processing line also comprises a cooler 3. The cooler 3 receives at the inlet the cooked food products from the cooker 2. The cooler 3 is in this instance provided with a thermal processing device 5. The thermal processing devices 4 and 5 may be of identical type with thermal processing liquids which are suitable for cooking in the case of the thermal processing device 4 and cooling in the case of the thermal processing device 5. The processing line may be provided only with the thermal processing device 4 or only the thermal processing device 5. The cooler 3 provides at the outlet food products at the storage temperature. The food products may then be stored in a cold room or be subjected to other processing operations in other machines which are not illustrated.

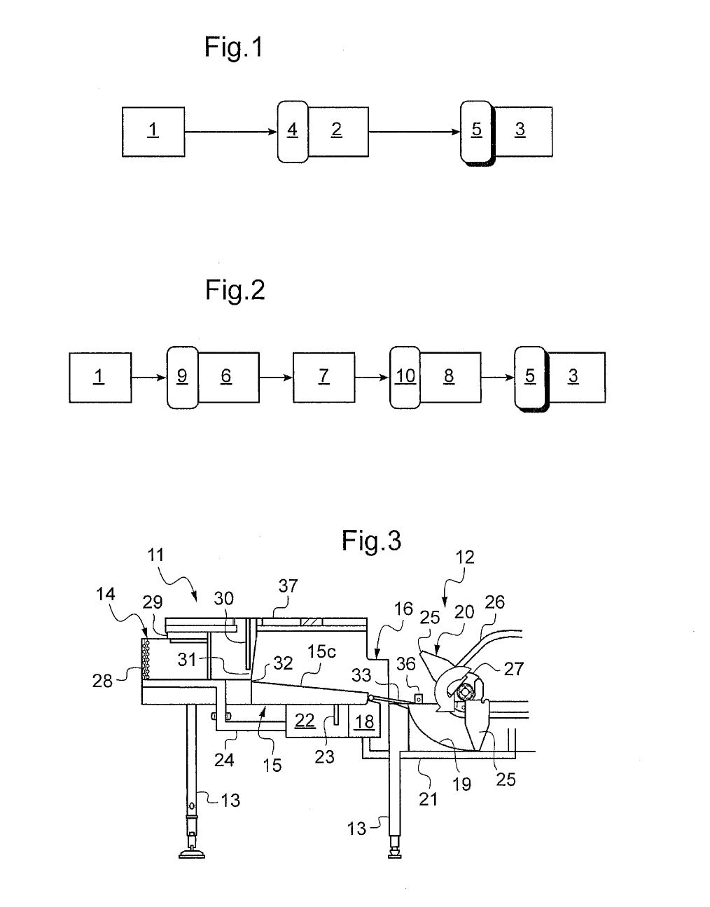

In the embodiment illustrated in FIG. 2, the thermal processing line comprises a pushing device 1, a pre-cooker 6, a packaging machine 7, a pasteuriser 8 and a cooler 3, arranged in this order. The pushing device 1 and the cooler 3 can be of the same type as in the previous embodiment. The pre-cooker 6 in this instance is provided with a thermal processing device 9. The pre-cooker 6 may be of a similar type to the cooker 2 of the embodiment of FIG. 1. The pre-cooker 6 may provide pre-cooking for a period of time less than the cooking time with the cooker 2. The pre-cooker 6 supplies to the packaging machine 7 at the outlet food products which are pre-cooked. The packaging machine 7 covers the food products with a package or packaging which generally provides mechanical and bacteriological protection. The food products can be packaged as a unit or in batches. The food products can be packaged between two sheets of synthetic material, for example, based on polyethylene. The packaging machine 7 provides at the outlet the packaged food products. The pasteuriser 8 is provided with a thermal processing device 10 in order to obtain adequate pasteurising values. The pasteuriser 8 is configured to comply with the standards in force which may demand a temperature, a core temperature, or a period of time at a given temperature. The pasteuriser 8 provides at the outlet the packaged and pasteurised food products which have a relatively high temperature. The cooler 3 provided with the thermal processing device 5 receives the food products from the pasteuriser 8 and ensures that they are cooled to a conservation temperature. The thermal processing devices 9, 10 and 5 of the thermal processing line of FIG. 2 may be present in different combinations and there may be 1, 2 or 3 of them in the thermal processing line.

The thermal processing devices 4, 9 and 10 ensure processing by the application of heat. The thermal processing devices 4, 9 and 10 generally operate in water. The thermal processing device 5 ensures treatment by the application of cold. The thermal processing device 5 can operate in water to which salt or another additive has been added in order to decrease the temperature of the brine to below 0° C.

In the embodiment illustrated in FIGS. 3 to 5, the thermal processing device 4 comprises a receptacle 11 and a thermal processing bath 12 which is arranged downstream of the receptacle 11. The receptacle 11 may generally be in the form of a table which rests on feet 13. The receptacle 11 has a cross-section which is generally in the form of a chute. The chute comprises a base and two lateral walls. The receptacle 11 comprises a supply of thermal processing water 14 which provides thermal processing water to an upstream portion 14 of the receptacle in order to flow to a downstream portion 15. The device comprises a sluice 16 which is arranged downstream of the receptacle 11 in the flow direction of the thermal processing water. The thermal processing bath 12 is arranged downstream of the sluice 16. That is to say, the thermal processing water is provided in the upstream portion 14, flows into the downstream portion 15, into the sluice 16 then joins the thermal processing bath 12. The thermal processing bath 12 may have a substantially constant level of thermal processing water. To this end, the thermal processing bath may comprise an overflow arrangement 17 which recovers the excess thermal processing water in the bath 12. The overflow arrangement 17 can be connected to a pump 18 which opens into the supply of thermal processing water 14. The output of the pump 18 can be completely directed to the supply of thermal processing water 14. Alternatively, the outlet of the pump 18 can be partially directed to the supply of thermal processing water 14 and partially to the thermal processing bath 12 in order to ensure agitation of the thermal processing water in the bath 12. Good homogeneity of temperature in the bath 12 is obtained.

The thermal processing bath 12 comprises a vessel 19 of thermal processing water which is open at the top and which is configured to provide a sufficient depth of thermal processing water for cooking food products and a sufficiently homogeneous temperature of thermal processing water. The overflow arrangement 17 is arranged in or at the edge of the vessel 19. The overflow arrangement 17 is connected to the pump 18 via a conduit 21. A store 22 for thermal processing water can be associated with the pump 18. The store 22 for thermal processing water may comprise a heating element 23, for example, a heat-exchanger or an electrical resistor. A conduit 24 is mounted between the pump 18 or the store 22 and the upstream portion 14 of the receptacle 11 in order to thus convey the thermal processing water into the receptacle 11.

The thermal processing bath 12 also comprises a timing member 20. The timing member 20 comprises an endless mechanism. The timing member 20 comprises a plurality of vanes 25 which are transverse with respect to the movement direction of the food products. The vanes 25 are supported at each of the ends thereof by a chain which moves in a rail 26. Toothed wheels drive the chain in the rail 26. The vanes 25 move in accordance with an upper trajectory portion out of the thermal processing water and a lower trajectory portion in contact with the thermal processing water. The depth of water of the vessel 19 is substantially constant in order to promote the homogeneity of the temperature. The longitudinal ends of the vessel 19 are rounded in order to conform to the path of the corresponding end of the vanes 25 whilst leaving a small space between the walls of the vessel 19 and the lower ends of the vanes 25. The lower ends of the vanes 25 are intended to be understood in this instance to be the end which is located in a lower position when the vane 25 is in contact with the thermal processing water. The overflow arrangement 17 can be arranged on one of the edges of the vessel 19, beyond the vanes 25. The vanes 25 are moved in the direction illustrated by the arrow of FIG. 3.

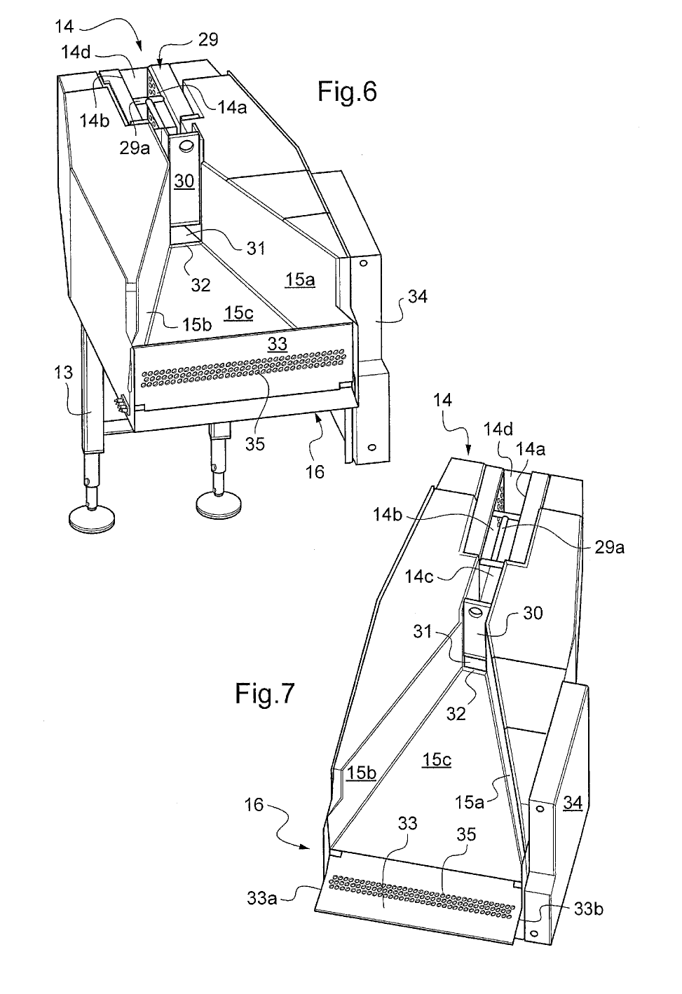

The receptacle 11 and the sluice 16 are illustrated in greater detail in FIGS. 6 and 7. The upstream portion 14 of the receptacle 11 comprises lateral edges 14a and 14b which are substantially parallel, a base 14c which is substantially horizontal or which has a slight downstream inclination, an upstream wall 14d and a thermal processing water supply 28. The thermal processing water supply 28 comprises a plurality of holes which are arranged in one or more rows which are vertically aligned and which are provided in the lateral walls 14a and 14b close to the upstream wall 14d. The lateral walls 14a and 14b may belong to a cartridge 29 which can be manipulated using a handle 29a and which allows the thermal processing water from the conduit 24 to be distributed to the holes provided in the lateral walls 14a and 14b. Preferably, the holes are substantially symmetrical forming a bilateral water supply. A flow of the thermal processing water in a downstream direction is thus promoted, reducing any possible stagnation zones for the thermal processing water.

The upstream portion 14a is in the form of a corridor, for example, narrow and tall. The width and height dimensions of the corridor formed in this manner can be determined by the diameter and the density of the food products to be thermally processed. The risk of impacts between the food products and the walls of the upstream portion 14 are thus limited. The upstream portion 14 also comprises a valve 30 which forms a downstream wall. The valve 30 leaves open a passage which forms an outlet 31 for the thermal processing water. The outlet 31 is axial with respect to the movement direction of the thermal processing water and the food products. The valve 30 can be controlled in accordance with the level of thermal processing water desired in the corridor of the upstream portion 14, the diameter of the food products, the discharge speed desired for the food products, etc. The outlet 31 is rectangular. The valve 30 is in the form of a rectangular component which is provided at the upper portion with a hole which facilitates gripping. The valve 30 can be manually adjusted in terms of height. The clamping can be achieved with a screw for fixing the valve 30 in position.

The downstream portion 15 of the receptacle extends from the valve 30. The downstream portion 15 comprises lateral walls 15a and 15b which are symmetrical and diverge in a downstream direction, and a trapezoidal base wall 15c. The base wall 15c is inclined in a downward direction, in particular through an angle of between 5° and 25°. The lateral walls 15a and 15b are connected to the lateral walls of the upstream portion 14 by means of welding or by means of a single metal sheet being folded. The base wall 15c is connected to the base wall 14c of the upstream portion 14, directly or optionally with a projection 32 which forms a threshold. The projection 32 has a height of between 1 and 5 cm. The projection 32 may be vertical.

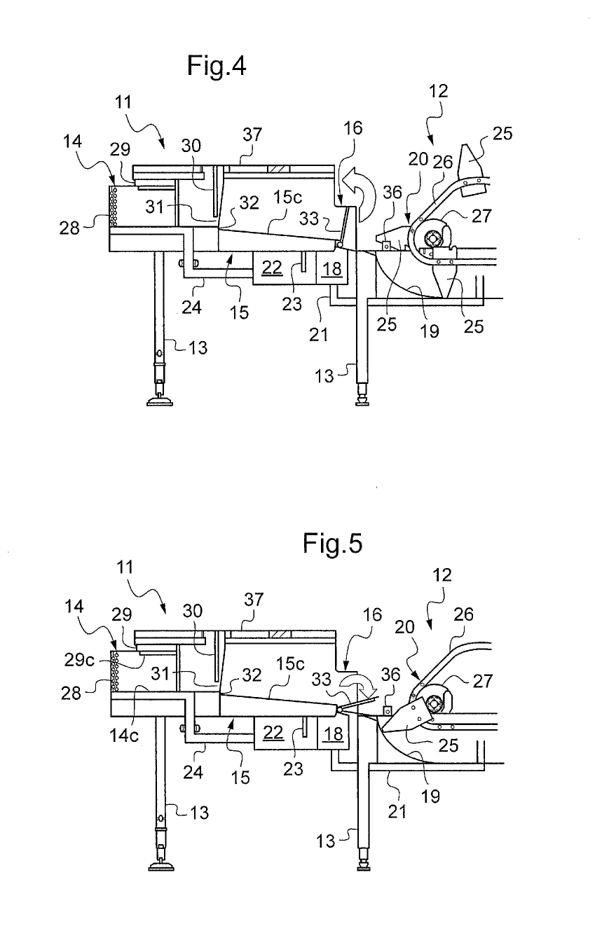

The downstream portion 15 joins the sluice 16 in the downstream direction. The sluice 16 comprises lateral and base walls which are common to the downstream portion 15. The sluice 16 comprises a tilting door 33. The door 33 is mounted pivotably about a substantially horizontal shaft. The shaft is arranged at a level which is very slightly lower than the level of the base wall 15c. In an open position, the door 33 may be flush with the base wall 15c. In an open position, the door 33 is arranged downstream of the tilting axis. In the closed position, the door 33 is raised upwards and is substantially perpendicular with the base wall 15c, see FIG. 4. The tilting of the door 33, between the open position and the closed position, is provided by a motor-driven device or a jack which is arranged in a casing 34 which is mounted adjacent to the downstream portion 15 and the sluice 16.

The door 33 is in the form of a rectangle whose length is arranged transversely relative to the movement direction of the thermal processing water and the food products. Short sides 33a and 33b of the door 33 are raised upwards in the closed state. The short sides 33a and 33b are at a distance from the lateral walls 15a and 15b which is significantly smaller than the diameter of the food products. The distance can be between 0.5 and 2 mm. The open door 33 is arranged with an inclination which is substantially equal to or slightly greater than the inclination of the base wall 15c of the downstream portion 15. Braking of the thermal processing water which passes above the door 33 in the open position is thus avoided.

A plurality of holes 35 are provided in the door 33. In the embodiment illustrated, the holes 35 are arranged in three rows parallel with the length of the door 33. The holes 35 are arranged substantially between one third and two thirds of the width of the door 33. The holes 35 allow the passage of thermal processing water whilst acting counter to the passage of the food products. The thermal processing water is thus prevented from overflowing above the upper edge of the door 33 in the closed position, which overflow would risk carrying along the food products. In this manner, the door 33 in the closed position comprises a solid lower portion, an open-work intermediate portion and a solid upper portion promoting sufficient accumulation of thermal processing water to ensure the immersion of the food products whilst preventing undesirable overflow.

The position of the door 33 of the sluice 16 is indexed to the presence or absence of a vane 25 opposite the sluice 16 and is capable of forming an obstacle for food products moved by the thermal processing water from the downstream portion 15 and from the sluice 16 towards the vessel 19. To this end, the thermal processing bath 12 is provided with a sensor 36 for detecting the presence of a vane 25 at the opening of the sluice 16. The sensor 36 may comprise a photoelectric cell or a mechanical device. The sensor 36 is connected to the casing 34 for motorisation of the door 33 of the sluice 16. In the position illustrated in FIG. 4, a vane 25 is located opposite the sensor 36. The vane 25 is also opposite the receptacle 11 and the sluice 16. Access to the thermal processing bath 12 is therefore not desirable for food products. The sensor 36 detects the presence of the vane 25 and brings about, via the motorisation casing 34, the tilting of the door 33 in the direction illustrated by the arrow of FIG. 4 as far as the closed position. The timing member 20 also comprises a vane 25 which is in contact with the thermal processing water of the vessel 19 and whose movement brings about the corresponding movement of the food products present in the thermal processing water upstream of the vane 25 in front of the sensor 36. Another vane 25 is on the return trajectory out of the thermal processing water.

When the door 33 is in the closed position, the thermal processing water and the food products from the outlet 31 accumulate in the sluice 16. A portion of the water flows via the holes 35 provided in the door 33. The accumulation of water in the sluice 16 is sufficient to continue the thermal processing of the food products and to prevent the occurrence of impacts between food products or of food products against the walls.

Then, the timing member 20 continues its movement. The vane 25 engages in the vessel 19, see FIG. 5. The sensor 36 is released from the vane 25 and controls by means of the motorisation casing 34 the tilting of the door 33 in the direction illustrated by the arrow of FIG. 5. The door 33 is illustrated in this instance in an advanced tilting position, quite close to the open position. In the position illustrated, the water which has accumulated already begins to flow above the door 33. The food products follow the movement of the thermal processing water. The open position illustrated in FIG. 3 is reached. The door 33 is open, in a position which is substantially aligned with the base 15c of the downstream portion 15, or with a slightly greater inclination in order to prevent slowing of the thermal processing water and the food products. The access to the vessel 19 is free. The sensor 36 is released. A vane 25 is already engaged in the vessel 19 over a horizontal portion of the trajectory thereof corresponding to a horizontal portion of the rail 26. The following vane 25 continues its return trajectory over an oblique descending portion of the rail 26. The following vane 25 does not interfere with the movement of the food products from the receptacle 11 and the sluice 16 into the vessel 19.

The receptacle 11 and the sluice 16 are provided with fluid-tight base and lateral walls so that the thermal processing water introduced by the supply 28 flows into the vessel 19. The receptacle 11 and the sluice 16 can be covered with covers 37 in order to provide good thermal insulation and protection for the food products. The receptacle 11 has a substantially continuous function with a continuous supply of water and a high supply rate of food products, for example, greater than 200 units per minute.

The sluice 16 allows a brief interruption, for example, of a few seconds, to the supply of food products to the thermal processing bath 12, allowing time for a vane 25 to release an inlet space for food products in the thermal processing bath 12. The vanes 25 may move at a constant speed.

The level of thermal processing water in the upstream portion 14 is determined by the water supply 28, and the position of the valve 30. This allows food products to be received from above, limiting the risk of impact and damage to the casing of the food product. Furthermore, the food product which falls into the thermal processing water from the upstream portion has a tendency to remain close to the base wall 14c owing to the thin streams of water directed towards the outlet 31. However, some food products, in particular elongate ones, may turn over in the upstream portion 14. It is advantageous to provide an outlet 31 which is of adequate size to allow two food products to pass through at the same time. After they have passed through the outlet 31, the food products accelerate owing to the small drop brought about by the presence of the projection which provides a difference in level between the base 14c and the base 15c and on the other hand by the inclination of the base 15c. The thermal processing water has a tendency to accelerate and spread over the increasing width of the downstream portion 15. The food products are separated from each other owing to the acceleration of the thermal processing water and are distributed in an equal manner over the increasing width of the downstream portion 15. When the sluice 16 is in the open position, the food products are conveyed directly by the thermal processing water into the thermal processing bath 12. The food products are already distributed over a significant width of the vessel upon entry into the bath. When the sluice is in the closed position, the food products are temporarily stored upstream of the door 33 with a pool which is formed by the thermal processing water retained by the door 33.

1. A device for thermally processing food products, characterised in that it comprises a receptacle which is intended to receive food products, a thermal processing bath downstream of the receptacle, the receptacle having a cross-section in the form of a chute, a supply of thermal processing water with the food products being moved into the receptacle by the water, and a sluice arranged downstream of the receptacle, the sluice having at least one open position which allows the thermal processing water and the food products moved by the thermal processing water to pass, and a closed position which retains the food products in thermal processing water, the thermal processing bath comprising a thermal processing water vessel which is arranged downstream of the sluice, and a member for timing the duration of the thermal processing operation, the timing member being provided with vanes, the sluice being synchronised with the timing member in a closed position when a vane is opposite the sluice and in an open position when the access to the thermal processing water vessel is free.

2. A device according to claim 1, wherein the supply of thermal processing water is continuous.

3. A device according to claim 1, wherein the receptacle is flared in a downstream direction.

4. A device according to claim 1, wherein the receptacle comprises a portion which is adjacent to the sluice and which is inclined in a downstream direction, preferably with an inclination of between 5 and 25°.

5. A device according to claim 1, wherein the sluice comprises a door which is articulated to a horizontal shaft.

6. A device according to claim 5, wherein the door, in the open position of the sluice, is located downstream of the horizontal shaft.

7. A device according to claim 1, wherein the sluice comprises a door which is provided with holes for the flow of water.

8. A device according to claim 1, wherein the sluice comprises a door which has lateral edges which are located at a distance from corresponding fixed edges that is independent of the position of the door.

9. A device according to claim 1, wherein the timing member further performs a driving function, a grouping function and a function involving extracting the food products at the outlet.

10. A device according to claim 1, wherein the receptacle comprises an upstream portion having a level of thermal processing water independent of the position of the sluice.

11. A device according to claim 10, wherein the upstream portion comprises an inlet for thermal processing water which is lateral relative to the movement of the food products and an axial outlet for thermal processing water and food products.

12. A device according to claim 11, wherein the thermal processing water inlet is bilateral.

13. A device according to claim 10, wherein the upstream portion comprises an upper opening for receiving food products, a base and an outlet for thermal processing water and food products in the direction towards the sluice.

14. A device according to claim 13, wherein the outlet is configured for a flow speed which is substantially equal to the speed of the food products at the inlet.

15. A device according to claim 13, wherein the upstream portion comprises an adjustment valve for the outlet.

16. A device according to claim 10, wherein the receptacle comprises a downstream portion which comprises a base which is offset from a base of the upstream portion by a threshold.

17. A device according to claim 10, wherein the receptacle comprises a downstream portion which comprises a base having an inclination which is less than or equal to the inclination of the sluice in the open position.

18. A processing line comprising a pushing device for food products, a cooker and a cooler, at least one of the cooker and the cooler comprising a device according to claim 1.

19. A processing line comprising a pushing device for food products, a pre-cooker, a packaging machine, a pasteuriser and a cooler, at least one of the pre-cooker, the pasteuriser and the cooler comprising a device according to claim 1.

20. A method for thermally processing food products comprising:
receiving the food products in a receptacle which has a cross-section in the form of a chute which is supplied with thermal processing water, a flow in the receptacle moving the food products, the food products being directed towards a bath by feed downstream of the receptacle, an open position of a sluice allowing the thermal processing water and the food products carried by the thermal processing water to pass and a closed position of the sluice retaining the food products in thermal processing water, then
the timed thermal processing of the food products in the bath comprising a vessel of water for thermally processing the food products, the introduction and the removal of the food products being controlled by vanes, the feed being synchronised with the timing member with a closure action when a vane is opposite the sluice and an opening action when the access to the bath is free.
